(19) United States
(12) Patent Application Publication
(10) Pub. No.: US 2014/0215358 A1
(43) Pub. Date: Jul. 31, 2014

(54) SCREEN SHARING SYSTEM AND CENTRAL APPARATUS

(71) Applicant: Sharp Kabushiki Kaisha, Osaka (JP)

(72) Inventor: Osamu URATANI, Osaka-shi (JP)

(73) Assignee: Sharp Kabushiki Kaisha, Osaka (JP)

(21) Appl. No.: 14/149,851

(22) Filed: Jan. 8, 2014

(30) Foreign Application Priority Data
Jan. 30, 2013 (JP) 2013-015185

(51) Int. Cl. G06F 3/048; H04L 29/06

(52) U.S. Cl. CPC G06F 3/048; H04L 65/403
USPC 715/753

(57) ABSTRACT

The screen sharing system of the present invention is such that, in a screen sharing system in which the plurality of display terminals are connected to the central apparatus, the central apparatus includes a data judging portion for judging a type of reception data received at a receiving portion, and the data judging portion, when judging that the reception data is screen data, gives an instruction to transmit the reception data to a display terminal registered as a guest terminal, and, when judging that the reception data is command data, gives an instruction to transmit the reception data to a display terminal registered as a host terminal.

This non-provisional application claims priority under 35 U.S.C. §119(a) on Patent Application No. 2013-015185 filed in JAPAN on Jan. 30, 2013, the entire contents of which are hereby incorporated herein by reference.

### FIELD OF THE INVENTION

The present invention relates to a screen sharing system and a central apparatus used for an electronic meeting and the like.

### BACKGROUND OF THE INVENTION

A screen sharing system is known that a plurality of display terminals are connected to a central apparatus and display content is able to be shared among the display terminals.

For example, in a meeting system of Japanese Laid-Open Patent Publication No. 2005-49993, as shown in FIG. 6A, a plurality of remote PCs 101 are wirelessly connected to a host PC 104 via a wireless network interface (I/F) 103. The host PC 104 is a computer which controls the meeting system, and executes a program which controls connection authentication for terminals, execution of commands for performing drawing and the like on a display 105, and a flow of execution through the entire meeting system.

The display 105 is a large-scale display for the meeting system, and has a display screen which is so large that all participants of a meeting are able to simultaneously see the display screen.

FIG. 6B is a view showing an example of an operation of the host PC 104 by the remote PC 101, and shows that a drawing operation of the remote PC 101 is directly reflected on the display of the large-scale display 105 connected to the host PC 104.

Accordingly, the host PC 104 constituting the meeting system is able to be operated using a mobile terminal like the remote PC 101.

As described above, the meeting system described in Japanese Laid-Open Patent Publication No. 2005-49993 is such that the display screen of the host PC 104 is shared with the remote PC 101 and drawing on the host PC 104 is able to be operated from the remote PC 101.

Meanwhile, in an electronic meeting, there is a case where, in a state where the plurality of remote PCs 101 are connected to the host PC 104, screen data displaying data or software that only a certain remote PC 101 has is transmitted to a different remote PC 101, and an operation of one remote PC 101 of a transmission source of the screen data is desired to be performed using the different remote PC 101 of a transmission destination of the screen data.

However, in the meeting system described in Japanese Laid-Open Patent Publication No. 2005-49993, since an operation command transmitted by the remote PC 101 is processed as the operation for the host PC 104, it is impossible to operate one remote PC 101 of the transmission source of the screen data using the different remote PC 101 of the transmission destination of the screen data.

### SUMMARY OF THE INVENTION

The present invention aims to realize a screen sharing system having a plurality of display terminals connected to a central apparatus, in which a display terminal of a transmission source of a shared screen is able to be operated using a display terminal of a transmission destination of the shared screen.

An object of the present invention is to provide a screen sharing system in which a plurality of display terminals are connected to a central apparatus, wherein the central apparatus has a receiving portion for receiving reception data including screen data and command data from the plurality of display terminals, a transmitting portion for transmitting the screen data and the command data to the plurality of display terminals, a data judging portion for judging a type of the reception data received by the receiving portion, and a terminal registering portion for registering one of the plurality of display terminals as a host terminal and registering at least one display terminal excluding the host terminal as a guest terminal, the host terminal outputs the screen data, the guest terminal outputs the command data for controlling the host terminal, and the data judging portion, instructs the transmitting portion to transmit the reception data to the display terminal registered as the guest terminal when judging that the reception data is the screen data, and instructs the transmitting portion to transmit the reception data to the display terminal registered as the host terminal when judging that the reception data is the command data.

### BRIEF DESCRIPTION OF THE DRAWINGS

FIG. 1A and FIG. 1B are views showing a network structure and a flow of data of the present invention;

FIG. 2 is a functional block diagram showing a flow of processing for transmitting screen data from a host terminal to a guest terminal in the screen sharing system of the present invention;

FIG. 3 is a functional block diagram showing a flow of processing for transmitting command data from a guest terminal to a host terminal in the screen sharing system of the present invention;

FIG. 4A and FIG. 4B are views showing a situation where coordinate conversion is performed in the screen sharing system of the present invention;

FIG. 5 is a view showing a structure of a transmitting portion of a central apparatus in a fourth embodiment; and

FIG. 6A and FIG. 6B are views showing a meeting system described in Japanese Laid-Open Patent Publication No. 2005-49993.

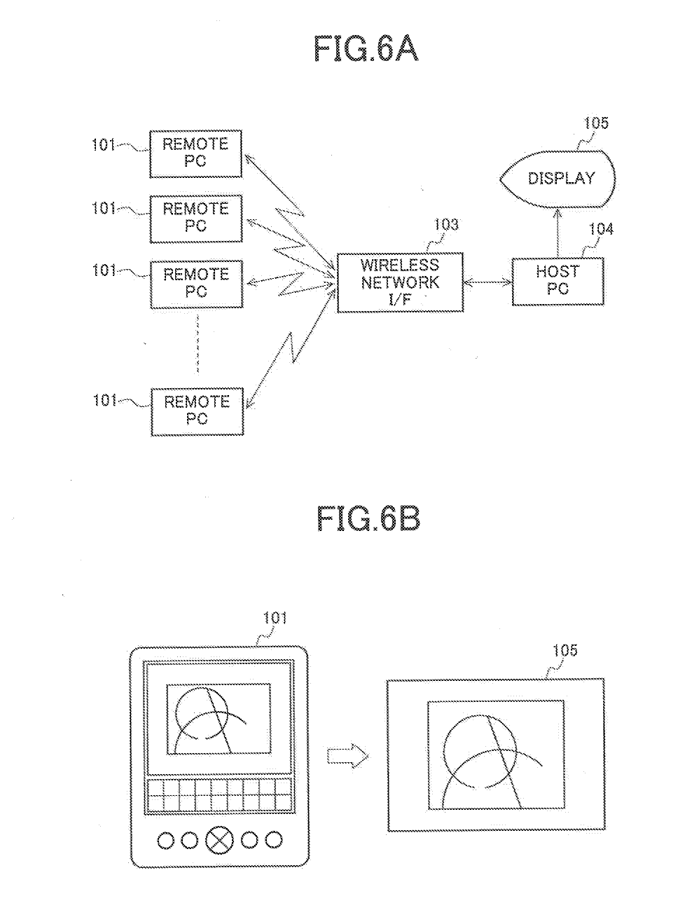

### PREFERRED EMBODIMENTS OF THE INVENTION

### First Embodiment

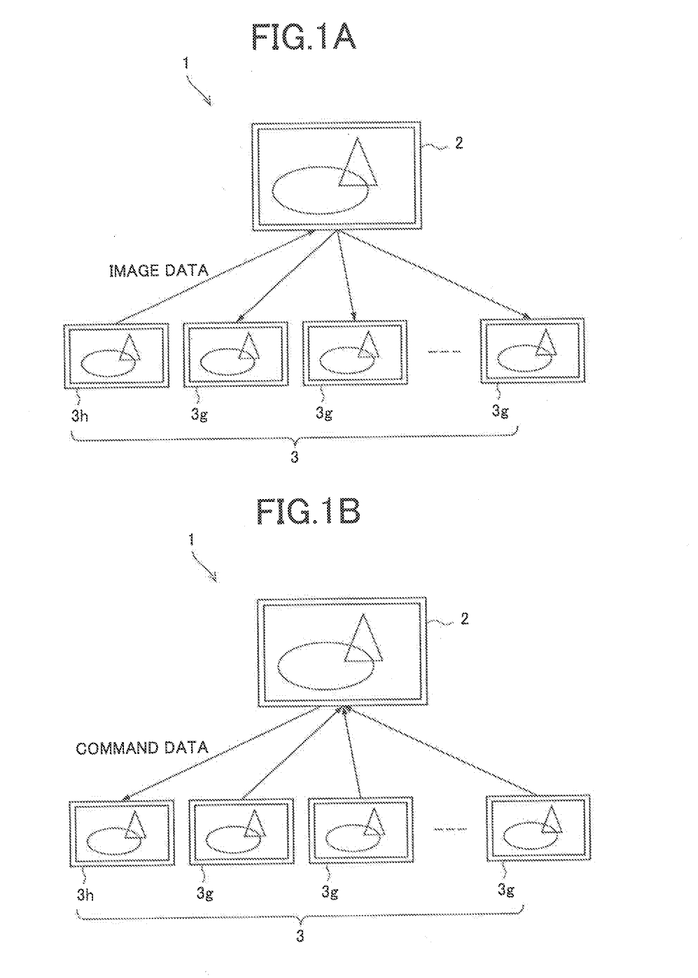

FIG. 1A and FIG. 1B are views showing a network structure of a screen sharing system 1 of the present invention. To a central apparatus 2 which has a role as a hub, a plurality of tablet terminals 3 are wirelessly connected. The tablet terminals 3 include one tablet terminal 3h functioning as a host terminal which is a transmission source of a shared screen and at least one tablet terminal 3g functioning as a guest terminal which is a transmission destination of the shared screen.

The central apparatus 2 and the tablet terminals 3 are wirelessly connected by a Wi-Fi system, but a connection method is not limited thereto, and other wireless system or wired connection may be possible.

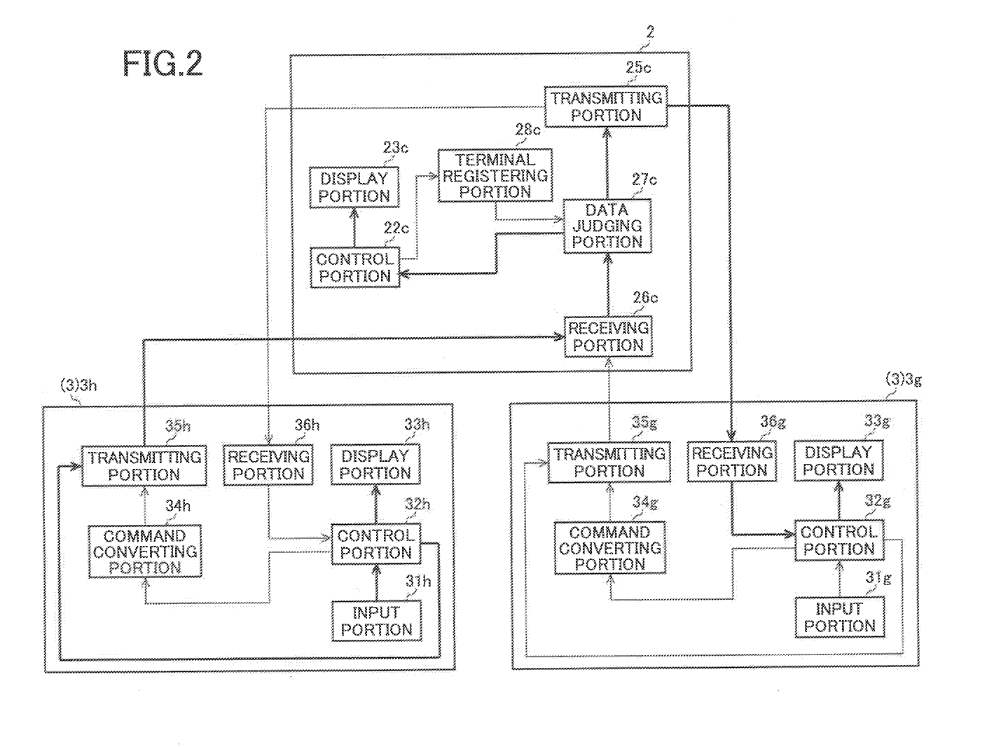

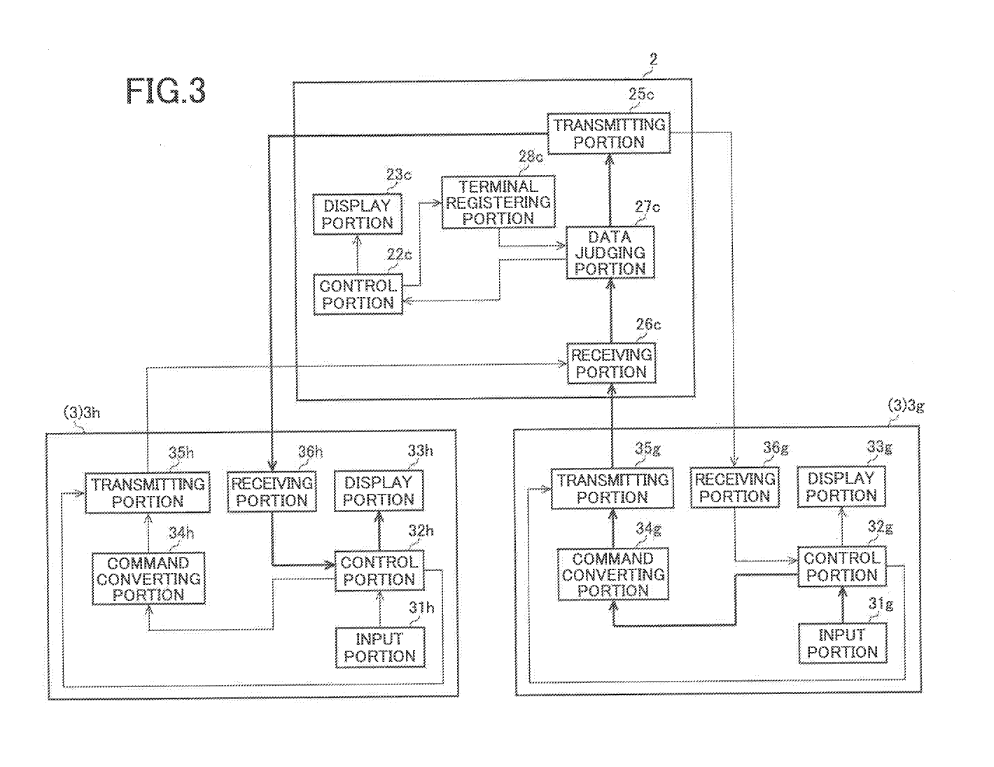

FIG. 2 and FIG. 3 show a block structure and a flow of processing of the central apparatus 2 and the tablet terminals 3. FIG. 2 shows a flow of processing for transmitting screen data for screen sharing from the tablet terminal 3h to the tablet terminal 3g by arrows of thick lines, in the same manner as shown in FIG. 1A. FIG. 3 shows a flow of processing for transmitting command data from the tablet terminal 3g to the tablet terminal 3h by arrows of thick lines, in the same manner as shown in FIG. 1B. Note that, as the command data, coordinate data showing an input coordinate, data of an input key code of a physical key, and the like are cited.

First, description will be given for the flow of the processing for transmitting screen data for screen sharing from the tablet terminal 3h to the tablet terminal 3g.

The central apparatus 2 has a control portion 22c, a display portion 23c, a transmitting portion 25c, a receiving portion 26c, a data judging portion 27c, and a terminal registering portion 28c. The terminal registering portion 28c registers one of the plurality of tablet terminals 3 connected to the central apparatus 2 as a host terminal for storage. Further, at least one of the tablet terminals excluding the host terminal is registered as a guest terminal to be stored. Note that, as to a method for registering the host terminal and the guest terminal, for example, each of the tablet terminals 3 makes a registration request to the central apparatus 2, and as to the host terminal, the terminal which has made the request earliest may be registered as the host terminal, or the host terminal and the guest terminal may be specified by the central apparatus 2 itself to be registered.

The tablet terminal 3h which is the host terminal is provided with an input portion 31h, a control portion 32h, a display portion 33h, a command converting portion 34h, a transmitting portion 35h, and a receiving portion 36h. Note that, the tablet terminal 3g which is the guest terminal also has the same structure as that of the tablet terminal 3h, and is provided with an input portion 31g, a control portion 32g, a display portion 33g, a command converting portion 34g, a transmitting portion 35g, and a receiving portion 36g. The structure of the tablet terminal 3h and the tablet terminal 3g are the same and able to be replaced with each other.

Input performed at the input portion 31h of the tablet terminal 3h is processed by the control portion 32h, and the display content after the processing is displayed on the display portion 33h. The input portion 31h is to be a touch panel integrated with the display portion 33h, but may be an input device such as a physical key or a mouse.

Moreover, the display content processed by the control portion 32h is passed to the transmitting portion 35h in a format of screen data. The transmitting portion 35h transmits the received screen data to the central apparatus 2. Note that, the screen data is data that a display screen of the display portion 33h is made in a transmittable format, and may be image data or object data showing a type or a position of a display object. In addition, the image data and the object data may indicate a whole or a part of a screen displayed on the display portion 33h. Description will be given below assuming that image data obtained by capturing the display portion 33h is used as the screen data.

The central apparatus 2 passes data received at the receiving portion 26c to the data judging portion 27c. The data judging portion 27c judges a type of the received data. Here, the judged type is to be screen data, and in this case, the received data is passed to the control portion 22c and the transmitting portion 25c. Note that, when it is configured so that the transmitting portion 25c includes the data judging portion 27c, the transmitting portion 25c may judge a type of the data.

The control portion 22c performs control to display the received image data on the display portion 23c. Moreover, the data judging portion 27c instructs the transmitting portion 25c to transmit the received image data to at least one tablet terminal 3g functioning as the guest terminal.

When receiving the image data at the receiving portion 36g, the tablet terminal 3g which is the guest terminal passes the data to the control portion 32g. The control portion 32g performs control to display the received image data on the display portion 33g.

By performing the processing as described above, the content displayed on the display portion 33h of the tablet terminal 3h as the host terminal is displayed on the display portion 33g of the tablet terminal 3g as the guest terminal via the central apparatus 2 and on the display portion 23c of the central apparatus 2, and sharing of a screen is performed. Note that, in the first embodiment, the tablet terminal 3h and the tablet terminal 3g have exactly the same display content.

Next, description will be given for a flow of processing for operating the tablet terminal 3h as the host terminal by input to the input portion 31g of the tablet terminal 3g as the guest terminal 3g, with the use of FIG. 3.

When input is performed at the input portion 31g of the tablet terminal 3g, coordinate data of the input is transmitted to the command converting portion 34g via the control portion 32g. When the command data is the coordinate data, the command converting portion 34g performs conversion of the coordinate as necessary and passes the result to the transmitting portion 35g, but since the tablet terminal 3h and the tablet terminal 3g have exactly the same display content in the present embodiment as described above, the coordinate conversion is not performed actually. The transmitting portion 35g transmits the received coordinate data to the central apparatus 2.

The receiving portion 26c of the central apparatus 2 passes the received coordinate data to the data judging portion 27c. The data judging portion 27c judges a type of the received reception data. Here, the judged type is to be command data, and in this case, the data judging portion 27c instructs the transmitting portion 25c to transmit the reception data to the tablet terminal 3h as the host terminal.

Then, the tablet terminal 3h passes the coordinate data received at the receiving portion 36h to the control portion 32h. The control portion 32h treats the coordinate data as being the same as coordinate data of input performed in its own input portion 31h, and processes the input by the coordinate data. Further, the control portion 32h performs control to display the state of the screen as a result of the processing on the display portion 33h and transmits the display content of the display portion 33h as image data to the central apparatus 2 through the transmitting portion 35h. The subsequent action is the same as the processing of screen sharing described above with the use of FIG. 2, and the display content of the tablet terminal 3h is displayed on the display portion 23c and the display portion 33g of the tablet terminal 3g by the central apparatus 2, followed by sharing.

Accordingly, for example, when a “save” button which is at a predetermined coordinate in a shared image transmitted from the tablet terminal 3h is pressed on a touch panel of the input portion 31g of the tablet terminal 3g, the coordinate data is transmitted to the tablet terminal 3h and processed in the same manner as that a button is pressed at the input portion 31h of the tablet terminal 3h, and the display content of the processing result is transmitted back to the tablet terminal 3g as image data of the shared image.

With this arrangement, it is possible to operate a display terminal of a transmission source of a shared screen using a display terminal of a transmission destination of the shared screen in the screen sharing system in which the plurality of display terminals are connected to the central apparatus. Such a remote operation requires that only command data such as coordinate data is transmitted from the guest terminal to the host terminal, and, for example, even in such a case where the guest terminal does not have a software which is activated in the host terminal, it becomes possible to operate the host terminal from the guest terminal.

Note that, by connecting the guest terminal and the host terminal directly, it becomes possible to operate the host terminal from the guest terminal, but there may be a problem that an operation other than the intended screen operation is executed. Since the guest terminal and the host terminal are not connected directly, the present invention has an advantage of suppressing occurrence of such a problem in the security.

Moreover, coordinate data by touch input is used as command data in the above-described example, but without limitation thereto, the command data may be coordinate data by click with a mouse or information of a key code by a physical key.

Moreover, input performed at the input portion 31h is processed by the control portion 32h to be displayed on the display portion 33h in the present embodiment, but without limitation thereto, input performed at the input portion 31h may be transmitted to the central apparatus 2 via the control portion 32h and the transmitting portion 35h, judged as command data by the data judging portion 27c of the central apparatus 2, and sent back to the tablet terminal 3h by the transmitting portion 25c. The sent-back command data is returned to the control portion 32h via the receiving portion 36h, and the result of processing at the control portion 32h is displayed on the display portion 33h. With this arrangement, the control portion 32h is able to deal with the received input data without distinguishing whether the data is input of the own terminal or input transmitted from other terminal.

Further, in the present embodiment, among the tablet terminals 3 connected to a network, those which are not the host terminal are all regarded as the guest terminals, but, in addition thereto, a host candidate terminal which functions as neither the host terminal nor the guest terminal may be included. The host candidate terminal transmits screen data of a display portion of the own terminal to the central apparatus 2. On the other hand, the central apparatus 2 transmits only one of the screen data transmitted from a plurality of host candidate terminals to the tablet terminal 3g which is the guest terminal. Accordingly, only one of the plurality of host candidate terminals functions as the host terminal and the other host candidate terminals remain as they are. The central apparatus 2 transmits the command date only to the host terminal which receives the screen data even when there are host candidate terminals as described above.

### Second Embodiment

In a second embodiment, description will be given for a case where the display portion 33h of the tablet terminal 3h and the display portion 33g of the tablet terminal 3g are different in a display form. Note that, the same reference numerals are assigned to portions in common with the first embodiment, and description thereof will be omitted.

In the second embodiment, the tablet terminal 3g which is the guest terminal is able to switch a self-operation mode and a remote operation mode by a predetermined operation. In the self-operation mode, input to the tablet terminal 3g is not transmitted to the central apparatus 2 and processed as input to the own terminal. Accordingly, the tablet terminal 3g is able to perform enlargement/reduction, position movement and the like of screen data of a shared screen which is received from the tablet terminal 3h via the central apparatus 2 without changing the display form of the tablet terminal 3h.

On the other hand, in the remote operation mode, as explained in the first embodiment, coordinate data of input to the tablet terminal 3g is transmitted to the tablet terminal 3h via the central apparatus 2, and the tablet terminal 3h performs processing according to the received coordinate data.

In this manner, when the self-operation mode and the remote operation mode are able to be switched, the display content of the tablet terminal 3g and the display content of the tablet terminal 3h do not necessarily match, and therefore, there is a case where the coordinate of the position intended by a user as to the input performed at the tablet terminal 3g is different from the coordinate of the corresponding position of the tablet terminal 3h.

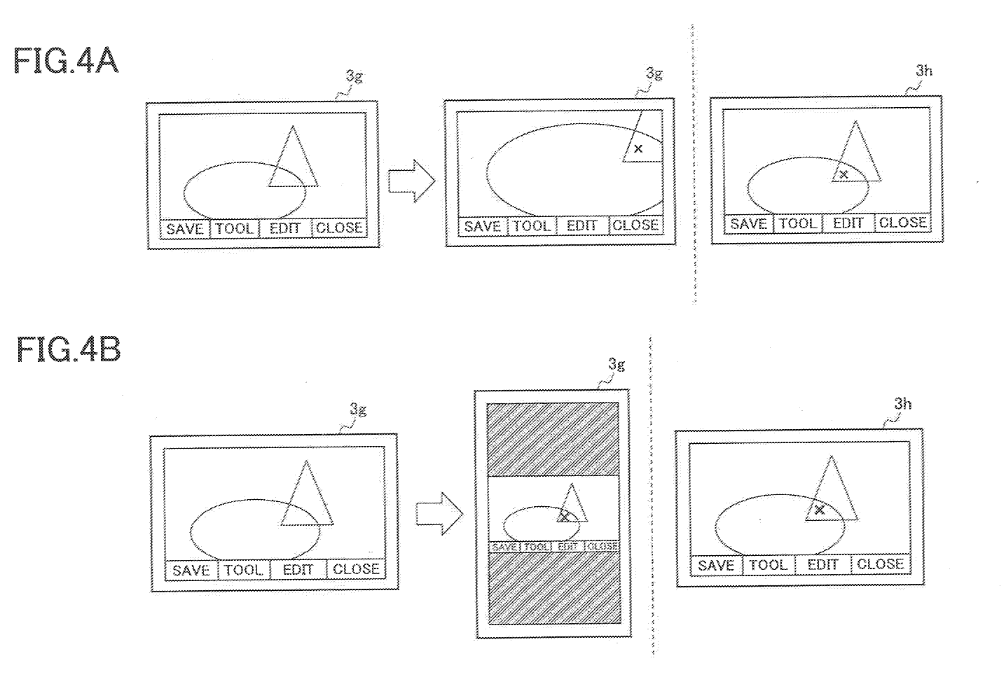

Specifically, as shown as a change from a left view to a central view of FIG. 4A, a case is cited where an enlargement operation is performed in the self-operation mode of the tablet terminal 3g as the guest terminal and the display content is different from that of the tablet terminal 3h as the host terminal, or the like.

In such a case, the tablet terminal 3g does not transmit the input coordinate data for the own display portion 33g as it is to the central apparatus 2, but needs to perform conversion into coordinate data of the corresponding position of the display portion 33h of the tablet terminal 3h to transmit to the central apparatus 2. Description will be given below for conversion of coordinate data.

When the tablet terminal 3g is switched to the remote operation mode and a certain coordinate on the touch panel of the tablet terminal 3g is touched as shown by a mark “X” in the central view of FIG. 4A, the input portion 31g of the tablet terminal 3g detects the input and passes the coordinate data to the command converting portion 34g via the control portion 32g. At the command converting portion 34g, by referring to an enlargement rate and a display position of screen data, the received coordinate data is converted into coordinate data of the corresponding position in the display portion 33h of the tablet terminal 3h based on a relative position thereof. That is, since the position shown by the mark “X” in the tablet terminal 3g of the central view of FIG. 4A is input for an area where an ellipse and a triangle are overlapped, the conversion of the coordinate is performed so that input is performed for an area where an ellipse and a triangle are overlapped also in the tablet terminal 3h of a right view of FIG. 4A as well.

The transmitting portion 35g of the tablet terminal 3g transmits this converted coordinate data to the central apparatus 2, and as explained in the first embodiment, the central apparatus 2 transmits the coordinate data to the tablet terminal 3h by the transmitting portion 25c after judging that the data received by the data judging portion 27c is coordinate data which is one of the command data.

As explained in the first embodiment, the tablet terminal 3h passes the coordinate data received at the receiving portion 36h to the control portion 32h and performs control to display the processing result on the display portion 33h. Further, screen data of screen display of the processing result is transmitted to the central apparatus 2 to be shared.

A left view and a central view of FIG. 4B show a situation where the tablet terminal 3g as the guest terminal is changed to be held from laterally to longitudinally. In a case where it is impossible to directly perform display depending on a holding direction because of difference of an aspect ratio of the tablet terminal 3, for example, screen data of display content of the tablet terminal 3h is reduced and displayed on a center part of the display portion 33g of the tablet terminal 3g. In this state, also in a case where a certain coordinate on the touch panel of the tablet terminal 3g is touched as shown by the mark “X” in the central view of FIG. 4B as well, the coordinate data of the input performed for the tablet terminal 3g is converted by the command converting portion 34g and transmitted to the tablet terminal 3h through the central apparatus 2 to be processed.

With this arrangement, in the screen sharing system in which the plurality of display terminals are connected to the central apparatus, even when display is different between the display terminals as well, it is possible to operate the display terminal of a transmission source of a shared screen using the display terminal of a transmission destination of the shared screen.

Note that, a case where resolution of the terminal is different or a case where a size or a position of a window of software of screen sharing is different is considered as a case where a display form is different between the display terminals which perform screen sharing without limitation to the case where enlargement/reduction or position movement are performed as described above. In such a case as well, information of the input coordinate in the own terminal is not transmitted as it is to the central apparatus 2, but, based on a relative position of screen data, the coordinate data is converted so that the position indicated by the input coordinate in the guest terminal matches the position in the host terminal and transmitted to the central apparatus 2, thus making it possible to realize the remote operation intended by the user.

Note that, the coordinate conversion described above is performed when command data is coordinate data, and in a case where command data is, for example, key code, the command converting portion 34g performs nothing and transfers the key code as it is to the transmitting portion 35g.

### Third Embodiment

In a third embodiment, description will be given for that, in the remote operation mode, coordinate data of input performed in the tablet terminal 3g as the guest terminal is not transmitted to the tablet terminal 3h via the central apparatus 2 one by one, but a specific amount of coordinate data is treated collectively.

When a drag operation is performed on the touch panel of the input portion 31g of the tablet terminal 3g as the guest terminal, the command converting portion 34g does not transfer coordinate data to the transmitting portion 35g while the drag operation is being continued, and performs the transfer to the transmitting portion 35g as a coordinate data group of a drag start point and a drag end point when the drag operation ends.

When the coordinate data group is transmitted from the command converting portion 34g by the above-described processing, the transmitting portion 35g transmits the coordinate data group to the central apparatus 2.

Accordingly, in a case where input to the tablet terminal 3g is being continued, the tablet terminal 3h as the host terminal does not need to receive coordinate data one by one nor transmit the change to the central apparatus 2, and becomes possible to perform processing by a command data group collecting a series of coordinate input.

Note that, not without performing a transmission of coordinate data at all till when the drag operation is completed, even when the drag operation is being continued, the coordinate data may be transmitted to the transmitting portion 35g for each predetermined interval, for example, such as one second.

Moreover, the processing for collecting a series of command data as a command data group is not limited to the case of the above-descried drag operation, but may be the case of, for example, a double click operation with a mouse or character input by a keyboard. In the double click operation, for example, upon completion of the second click action, a coordinate that double click is performed may be transmitted to the transmitting portion 35g. In the character input by a keyboard, for example, for each of the specific number of input characters, the input key code group may be transmitted to the transmitting portion 35g.

With this arrangement, in the screen sharing system in which the plurality of display terminals are connected to the central apparatus, it is possible to operate the display terminal of a transmission source of a shared screen using the display terminal of a transmission destination of the shared screen, while reducing transmission quantity of the network.

### Fourth Embodiment

In a fourth embodiment, description will be given for that an appropriate transmission path is selected when devices are connected to each other in both wired and wireless manners.

The central apparatus 2 and the tablet terminal 3 in the present embodiment are connected by the MHL (Mobile High-definition Link) using a USB (Universal Serial Bus) terminal and an HDMI (High-Definition Multimedia Interface) terminal as the wired standard. Moreover, the connection is performed also by the Miracast which is used mainly for a transmission of a moving image as the wireless standard using Wi-Fi. However, each of the wired/wireless standards is not limited thereto.

In the present embodiment, each transmitting portion of the central apparatus 2, the tablet terminal 3h and the tablet terminal 3g has a wired transmitting portion, a wireless transmitting portion and a standard selecting portion. Note that, though description will be given below taking the transmitting portion 25c of the central apparatus 2 as an example, the transmitting portion 35h of the tablet terminal 3h and the transmitting portion 35g of the tablet terminal 3g also have the similar structure.

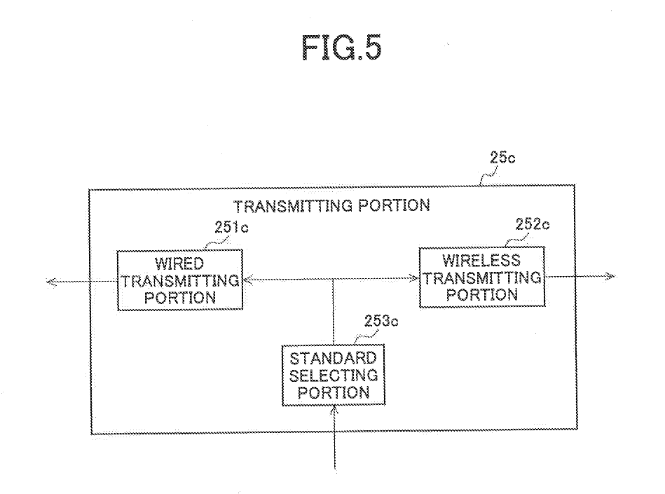

As shown in FIG. 5, the transmitting portion 25c of the central apparatus 2 has a wired transmitting portion 251c, a wireless transmitting portion 252c and a standard selecting portion 253c. The wired transmitting portion 251c performs a communication by the MFL described above, and the wireless transmitting portion 252c performs communication by the Miracast described above. The standard selecting portion 253c judges a type of data input to the transmitting portion 25c and gives an instruction to transmit the data to appropriate one of the wired transmitting portion 251c and the wireless transmitting portion 252c.

Accordingly, in a case where transmission of data is performed from the central apparatus 2 to the tablet terminal 3, for example, when it is judged that the type of the data is screen data, transmission/reception of the data is performed by the Miracast which is the standard suitable for the screen sharing. On the other hand, when it is judged that the type of the data is coordinate data, exchange of the data is performed by the MHL in which delay is less and which is suitable for transfer of control signals.

In this manner, in a case where the central apparatus 2 and the tablet terminals 3 are connected by a plurality of methods, by selecting a transferring method suitable for a type of data, it is possible, in a screen sharing system in which the plurality of display terminals are connected to the central apparatus, to operate a display terminal of a transmission source of a shared screen using a display terminal of a transmission destination of the shared screen, while improving image quality of image data and delay prevention performance.

As above, according to the present invention, it is possible, in a screen sharing system in which the plurality of display terminals are connected to the central apparatus, to operate a display terminal of a transmission source of a shared screen using a display terminal of a transmission destination of the shared screen.

1. A screen sharing system in which a plurality of display terminals are connected to a central apparatus, wherein
the central apparatus has
a receiving portion for receiving reception data including screen data and command data from the plurality of display terminals,
a transmitting portion for transmitting the screen data and the command data to the plurality of display terminals,
a data judging portion for judging a type of the reception data received by the receiving portion, and
a terminal registering portion for registering one of the plurality of display terminals as a host terminal and registering at least one display terminal excluding the host terminal as a guest terminal,
the host terminal outputs the screen data,
the guest terminal outputs the command data for controlling the host terminal, and
the data judging portion,
instructs the transmitting portion to transmit the reception data to the display terminal registered as the guest terminal when judging that the reception data is the screen data, and
instructs the transmitting portion to transmit the reception data to the display terminal registered as the host terminal when judging that the reception data is the command data.

2. The screen sharing system as defined in claim 1, wherein
the guest terminal has a command converting portion, and
the command converting portion converts coordinate data based on a relative position in the screen data to output to the central apparatus when the command data is the coordinate data.

3. The screen sharing system as defined in claim 2, wherein
the command converting portion collectively converts the command data into one command data group to output to the central apparatus.

4. The screen sharing system as defined in claim 1, wherein
the plurality of display terminals are connected to the central apparatus in accordance with a plurality of communication standards, and
the plurality of display terminals and the central apparatus further includes a standard selecting portion for switching the communication standards according to a type of data to be transmitted.

5. A central apparatus having
a receiving portion for receiving reception data including screen data and command data from the plurality of display terminals,
a transmitting portion for transmitting the screen data and the command data to the plurality of display terminals,
a data judging portion for judging a type of the reception data received by the receiving portion, and
a terminal registering portion for registering one of the plurality of display terminals as a host terminal and registering at least one display terminal excluding the host terminal as a guest terminal, wherein
the data judging portion,
instructs the transmitting portion to transmit the reception data to the display terminal registered as the guest terminal when judging that the reception data is the screen data, and
instructs the transmitting portion to transmit the reception data to the display terminal registered as the host terminal when judging that the reception data is the command data.
